(19) United States
(12) Patent Application Publication
(10) Pub. No.: US 2002/0106957 A1
(43) Pub. Date: Aug. 8, 2002

(54) Airbag fabric, method for its manufacture and its use

(75) Inventor: Philipp Ritter, Schwabisch Gmund (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/054,827

(22) Filed: Jan. 23, 2002

(30) Foreign Application Priority Data
Feb. 5, 2001 (DE) 101 05 043.7

(51) Int. Cl. B32B 5/18; B32B 5/22; B60R 21/16

(52) U.S. Cl. 442/208; 442/76; 280/728.1

(57) ABSTRACT

Airbag fabric, method for its manufacture and its use An airbag fabric is proposed with which, in order to increase the static friction of the yarns at the intersections of the warp and the weft, crystalline and/or amorphous particles are incorporated in at least some of the openings remaining between their intersections. The airbag fabric can be manufactured on a padding machine in that a strip of the raw fabric is passed through an aqueous dispersion of colloidal silicic acid and subsequently dried. The fabric is used for the manufacture of airbags.

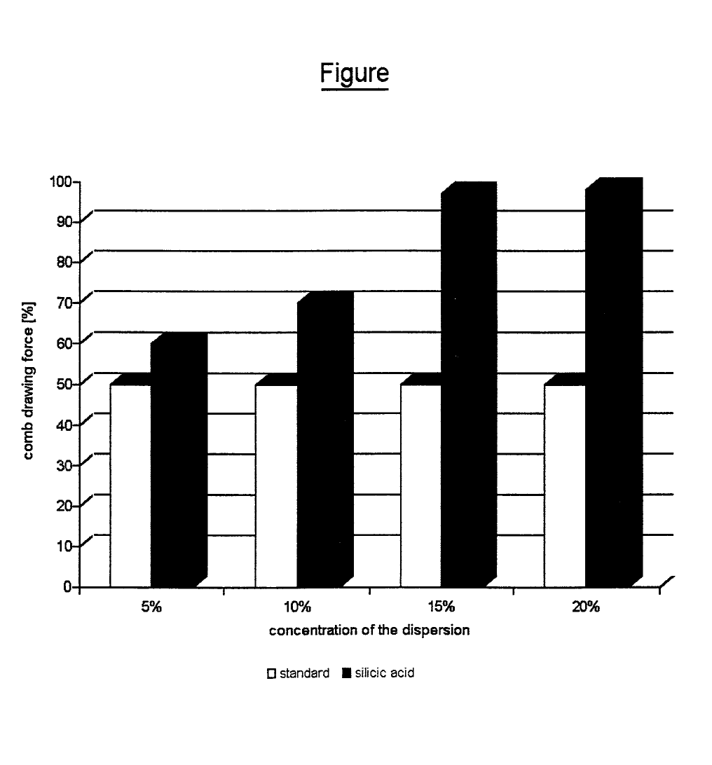

### SUMMARY OF THE INVENTION

The invention relates to an airbag fabric in which warp and weft threads made of synthetic fibers and/or filaments are woven together at such a density that the openings remaining between their intersections yield an at least microporous structure in the raw fabric.

The invention also relates to a method for the manufacture of the airbag fabric of the type described above as well as to its use.

### BACKGROUND OF THE INVENTION

The inflatable airbags known for the protection of vehicle occupants consist of at least two layers of a special fabric made for this purpose, said layers being either sewn or woven together. Between the at least two fabric layers, at least one chamber is formed that is inflated by being filled with gas in case of an accident. Since the inflation of such an airbag takes place within a very short period of time within the millisecond range, the airbag fabric, especially in the area of the connection zones between the upper and lower fabric layers, is subjected to high shear stresses, which can lead to a shifting of the relative position of the warp and weft threads with respect to each other, as a result of which the openings remaining between the intersections of the warp and weft threads are enlarged at especially stressed sites in the fabric, whereas said openings are reduced in size at other places. The risk is especially high in the case of sewn connections of two or more fabric layers, but it also exists with woven connections. The areas with enlarged openings lead to a markedly increased outflow of gas which, also because of the elevated gas temperatures, can lead to fabric damage and ultimately to the failure of the airbag.

With normal, loosely constructed fabrics, wovens and knits, it is a known procedure to apply a finish to these unstable textile structures so that they cannot shift by spraying them with polymers, e.g. with polyacrylate or polymethacrylate dispersions and to further process them after these polymers have hardened.

With airbag fabrics, however, making them completely shift-proof is not recommended since that would impermissibly diminish the tear propagation force, an important safety criterion of the fabric. In order to achieve high values for the tear propagation force, a slight shifting of the warp and weft threads relative to each other is indispensable.

### SHORT DESCRIPTION OF THE DRAWING

The sole FIGURE is a graph showing the relative comb drawing forces of the raw fabric (standard) and the final airbag fabric according to the present invention (silicic acid).

### DETAILED DESCRIPTION OF THE INVENTION

The invention is based on the objective of creating an airbag fabric with which the static friction between the warp and weft threads at the intersections of these two yarn systems which make up the fabric structure is increased in such a way that the shifting of the yarns under shear stress is rendered much more difficult, but is not completely eliminated, so that the tear propagation force of the fabric is not impermissibly reduced. The increased static friction between the yarns should be retained, even after a coating or finish and, in spite of the increased static friction of the yarns, the airbag should have sufficient flexibility so that an airbag made of the fabric can be folded together compactly and accommodated in the airbag modules commonly employed nowadays. Finally, the increase in the static friction between the yarns of the airbag fabric should be reproducible and should be resistant to thermal shocks and aging resistant for 15 years within the temperature range between −35° C. [−31° F.] and +85° C. [185° F.] required for automobiles. The materials used to increase the static friction have to be recyclable.

This complex task is achieved according to the invention with an airbag fabric of the type mentioned above in that crystalline and/or amorphous particles are incorporated in at least some of the openings situated between the intersections of warp and weft.

The incorporation of the crystalline and/or amorphous particles leads to a roughening of the structure of the fabric and to an increase of the static friction of the warp and weft threads at the intersections of both yam systems, without totally eliminating the shifting of the yams that is indispensable for the necessary tear propagation force of the fabric.

Preferably, the crystalline and/or amorphous particles consist of incombustible, inorganic material, especially of cation-active silicon dioxide, especially preferably of colloidal silicic acid, also known as colloidal silica. The colloidal silicic acid has a particle size distribution that is especially well-suited for the primarily mechanical incorporation of the particles into the microporous structure of the airbag fabric.

The warp and/or weft threads of the airbag fabric preferably consist of polyamide or polyester, the use of textured yams being preferred because of their intrinsic greater static friction as compared to untextured yam.

Before the incorporation of the crystalline and/or amorphous particles, the raw fabric is preferably present in the form of an uncoated flat fabric, but a two-layered double fabric that is partially sewn or woven together is especially preferred.

After the crystalline and/or amorphous particles have been incorporated, the airbag fabric is preferably provided with a coating or finish of polymeric material that is preferably made of a silicone.

The static friction between the two yarn systems, namely, the warp and the weft, that make up the fabric structure is at least 5% greater than that of untreated fabric having the same construction.

The airbag fabric according to the invention is made of a porous or at least microporous synthetic raw fabric and finished wet-chemically on a padding machine which is also known as a Foulard. With the method according to the invention, a strip of the raw fabric is passed through an aqueous dispersion of colloidal silicic acid, then dried and later optionally additionally coated with a polymer. The fabric strip is fed into the padding machine in a generally known manner by means of driven roller pairs and non-driven deflection rollers, at a maximum speed of 150 m/min, excess dispersion is squeezed off by nip rollers and the drying is likewise carried out in a known manner in closed or open systems while heat is supplied.

The aqueous dispersion used preferably has a concentration of 0.5% to 35% by weight of silicic acid. The pH value of the aqueous dispersion is preferably in the acidic range, that is to say, it is less than 7.

It is especially advantageous if the aqueous dispersion is compatible with cationic and/or non-ionic finishing agents since then additional textile auxiliaries can be added to the steep bath in the padding machine.

Preferably, the airbag fabric treated with the aqueous dispersion can be impregnated and/or laminated with a polymer, preferably with a silicone, after it has been dried.

The airbag fabric according to the invention is preferably used in the production of vehicle occupant restraint systems, especially side-impact airbags.

In the fabric test, the magnitude of the resistance that the fabric structure offers against the shifting of the yarn intersections can be approximated by determining the comb drawing force according to DIN 53 857, Part 1. The magnitude of the comb drawing force is determined by the static friction between the two yarn systems, namely, the warp and the weft, at their intersections. The higher this static friction, the greater the resistance against a shifting of the fabric structure. According to the invention, the static friction between the warp and the weft at their intersections is only improved to a degree at which the crystalline and/or amorphous particles used almost completely fill the microporous openings.

The FIGURE shows the relative comb drawing force of the raw fabric (standard) used for the invention and made of polyamide-6.6 and of the airbag fabric treated according to the invention (silicic acid) when aqueous silicic acid dispersions of varying concentrations are used (5%, 10%, 15% and 20% by weight). The graph shows that, when the airbag fabric is treated with a 5% silicic acid dispersion, already 60% of the maximum comb drawing force is reached, while with a 10% dispersion, 70% of the maximum comb drawing force is reached, with a 15% dispersion, already more than 95% of the maximum comb drawing force is reached, and with a 20% dispersion, almost 98% of the maximum comb drawing force is reached.

These values show that, by using the invention, it is indeed possible to greatly increase the static friction between the warp and weft threads without fully eliminating the shifting characteristics of the yarn intersections under shear stress, so that the tear propagation force is retained. The airbag fabric according to the invention can be coated with silicone and other polymers, yet it still retains sufficient flexibility to be folded up compactly. The achievable increase in the static friction is reproducible, the product is sufficiently resistant to thermal shocks and aging resistant between −35° C. [−31° F.] and +85° C. [185° F.], and the crystalline and/or amorphous particles used, preferably SiO₂, can be recycled.

1. An airbag fabric comprising intersecting warp and weft threads made of at least one of synthetic fibers and filaments and woven at such a density that openings remaining between their intersections yield an at least microporous structure in said fabric, wherein at least one of crystalline and amorphous particles are incorporated in at least some of said openings.

2. The airbag fabric of claim 1, wherein said crystalline and amorphous particles consist of incombustible, inorganic material.

3. The airbag fabric of claim 1, wherein said crystalline and amorphous particles consist of cation-active silica.

4. The airbag fabric of claim 1, wherein said particles are particles of colloidal silicic acid (colloidal silica).

5. The airbag fabric of claim 1, wherein at least one of said warp and weft threads are made of polyamide.

6. The airbag fabric of claim 1, wherein at least one of said warp and weft threads are made of polyester.

7. The airbag fabric of claim 1, wherein at least one of said warp and weft threads are made of textured yam.

8. The airbag fabric of claim 1, wherein said fabric, prior to said incorporation of at least one of crystalline and amorphous particles, is an uncoated flat fabric.

9. The airbag fabric of claim 1, wherein said fabric is a two-layered double fabric that is partially sewn or woven together.

10. The airbag fabric of claim 1, wherein said fabric has a coating or finish of polymeric material that has been applied after said incorporation of at least one of crystalline and amorphous particles.

11. The airbag fabric of claim 10, wherein said coating or finish consists of or comprises a silicone.

12. The airbag fabric of claim 1, wherein a static friction at the intersections between the warp and weft threads is present that is at least 5% greater than that of an untreated fabric having the same construction.

13. A method for the manufacture of an airbag fabric comprising intersecting warp and weft threads made of at least one of synthetic fibers and filaments and woven at such a density that openings remaining between their intersections yield an at least microporous structure in said fabric, wherein a synthetic raw fabric formed of said at least microporous structure is finished wet-chemically on a padding machine (Foulard) by passing a strip of the raw fabric through an aqueous dispersion of colloidal silicid acid, followed by a drying step, to form an airbag fabric having at least one of crystalline and amorphous silica particles incorporated in at least some of the openings between the intersections of warp and weft.

14. The method of claim 13, wherein said aqueous dispersion has a concentration of 0.5% to 35% by weight of silicid acid.

15. The method of claim 13, wherein said aqueous dispersion has a pH of less than 7.

16. The method of claim 13, wherein said aqueous dispersion is compatible with at least one of cationic and non-ionic finishing agents.

17. The method of claim 13, wherein said fabric, after said drying step, is coated with a polymer by impregnation or lamination or a combination thereof.

18. The method of claim 17, wherein said polymer is a silicone.

19. The airbag fabric of claim 1, wherein said airbag fabric forms part of a vehicle occupant restraint system.

20. The airbag fabric of claim 1, wherein said airbag fabric forms part of a side-impact airbag.
